(19) United States
(12) Patent Application Publication
(10) Pub. No.: US 2013/0073293 A1
(43) Pub. Date: Mar. 21, 2013

(54) ELECTRONIC DEVICE AND METHOD FOR CONTROLLING THE SAME

(71) Applicants: Seokbok JANG, Seoul (KR); Jungkyu CHOI, Seoul (KR); Juhee KIM, Seoul (KR); Jongse PARK, Seoul (KR); Joonyup LEE, Seoul (KR)

(72) Inventors: Seokbok JANG, Seoul (KR); Jungkyu CHOI, Seoul (KR); Juhee KIM, Seoul (KR); Jongse PARK, Seoul (KR); Joonyup LEE, Seoul (KR)

(73) Assignee: LG ELECTRONICS INC., Seoul (KR)

(21) Appl. No.: 13/236,732

(22) Filed: Sep. 20, 2011

(51) Int. Cl. G10L 21/00

(52) U.S. Cl. 704/275; 704/E21.001

(57) ABSTRACT

An electronic device, a system including the same, and a method for controlling the same are provided. The electronic device may select a specific electronic device to perform a user's voice command in an environment including a plurality of electronic devices capable of voice recognition. The embodiments of the present disclosure allows for interaction between the user and the plurality of electronic devices so that the electronic devices can be efficiently controlled in the N screen environment.

### BACKGROUND

1. Field

The embodiments of the present disclosure are directed to an electronic device that can efficiently provide various services in a smart TV environment and a method for controlling the electronic device.

2. Related Art

N screen refers to a user-centered service that allows multi-contents to be seamlessly shared or played anytime and everywhere through a further advanced smart system in the business structure including contents, platforms, networks, and terminals.

Before N screen appears, three-screen had been prevalent which is limited to a connection among web, mobile, and TVs. As smart devices evolve, technical standards have been developed to let users easily share and execute interpreting services between devices.

Among them, the DLNA is an industrial standard that permits a user to more easily associate a device with others, and this applies as an inevitable element for smart TVs, smart phones, tablet devices, laptop computers, or audio devices.

Under the N screen environment, the same contents can be displayed or controlled by a plurality of devices. Accordingly, the same contents can be played by a plurality of devices connected to one another, such as a mobile terminal, a TV, a PC, etc.

A need exists for various technologies that can control the plurality of electronic devices connected to one another over a network in the N screen environment.

### SUMMARY

Embodiments of the present disclosure provide an electronic device that can efficiently control a plurality of electronic devices capable of voice recognition by means of voice commands in a network environment including the plurality of electronic devices, a system including the same, and a method for controlling the same.

According to an embodiment of the present disclosure, there is provided an electronic device comprising a communication unit configured to perform communication with at least a first electronic device included in a group of related electronic devices; and a controller configured to: identify, for each electronic device included in the group of related electronic devices, a voice recognition result of a voice command input provided by a user, select, from among the group of related electronic devices, a voice command performing device based on the identified voice recognition results, and control the voice command performing device to perform a function corresponding to the voice command input.

The electronic device further comprising: a voice input unit configured to input voice command inputs, wherein the electronic device is included in the group of related electronic devices, and wherein the controller is configured to recognize the voice command input provided by the user based on input received through the voice input unit.

wherein the controller is configured to: identify, for each electronic device included in the group of related electronic devices, a voice recognition result that indicates whether or not recognition of the voice command input was successful at the corresponding electronic device, and select, from among the group of related electronic devices, a voice command performing device based on the identified voice recognition results that indicate whether or not recognition of the voice command input was successful.

wherein the voice command input provided by the user is a single voice command made by the user, wherein multiple electronic devices included in the group of related electronic devices receive voice input based on the single voice command such that the single voice command results in multiple voice inputs to the group of related electronic devices, and wherein the controller is configured to determine that the multiple voice inputs relate to the single voice command as opposed to multiple voice commands provided by the user.

wherein the controller is configured to: select, from among the group of related electronic devices, multiple voice command performing devices based on the identified voice recognition results, and control the multiple voice command performing devices to perform a function corresponding to the voice command input.

wherein the multiple voice command performing devices comprise the electronic device and the first electronic device.

And wherein the controller is configured to select only one electronic device from the group of related electronic devices as the voice command performing device based on the identified voice recognition results.

wherein the controller is configured to: identify, for each electronic device included in the group of related electronic devices, a distance from the user; and select the voice command performing device based on the identified distances from the user.

wherein the controller is configured to: identify, for each electronic device included in the group of related electronic devices, an average voice recognition rate; and select the voice command performing device based on the identified average voice recognition rates.

wherein the controller is configured to: identify, for each electronic device included in the group of related electronic devices, a type of application executing at a time of the voice command input provided by the user; and select the voice command performing device based on the identified types of applications executing at the time of the voice command input provided by the user.

wherein the controller is configured to: identify, for each electronic device included in the group of related electronic devices, an amount of battery power remaining; and select the voice command performing device based on the identified amounts of battery power remaining.

wherein the controller is configured to perform a function corresponding to the voice command input and provide, to the first electronic device, feedback regarding a performance result for the function corresponding to the voice command.

wherein, when the function corresponding to the voice command input is performed abnormally, the controller is configured to select the first electronic device as the voice command performing device and control the first electronic device to perform the function corresponding to the voice command input.

wherein the communication unit is configured to communicate with the first electronic device through a Digital Living Network Alliance (DLNA) network.

According to an embodiment of the present disclosure, there is provided a method for controlling an electronic device comprising: identifying, for each electronic device included in a group of related electronic devices, a voice recognition result of a voice command input provided by a user; selecting, from among the group of related electronic devices, a voice command performing device based on the identified voice recognition results; and outputting a control signal that controls the voice command performing device to perform a function corresponding to the voice command input.

The method further comprises receiving, at an electronic device included in the group of related electronic devices, the voice command input provided by the user, wherein the electronic device that received the voice command input provided by the user selects the voice command performing device and outputs the control signal.

According to an embodiment of the present disclosure, there is provided a system comprising: a first electronic device configured to receive a user's voice command; and

a second electronic device connected to the first electronic device via a network and configured to receive the user's voice command, wherein at least one component of the system is configured to: identify, for each of the first and second electronic devices, a voice recognition result for the user's voice command, select at least one of the first electronic device and the second electronic device as a voice command performing device based on the identified voice recognition results, and control the voice command performing device to perform a function corresponding to the user's voice command.

wherein the at least one component of the system is configured to select one of the first electronic device and the second electronic device as the voice command performing device based on the voice recognition results.

### BRIEF DESCRIPTION OF THE DRAWINGS

The embodiments of present disclosure will become more fully understood from the detailed description given herein below and the accompanying drawings, which are given by illustration only, and thus are not limitative of the present disclosure, and wherein:

FIGS. 1 and 2 are schematic diagrams illustrating a system of electronic devices according to embodiments of the present disclosure;

FIG. 3 is a conceptual diagram illustrating a Digital Living Network Alliance (DLNA) network according to an embodiment of the present disclosure;

FIG. 4 illustrates functional components according to the DLNA;

FIG. 5 is a block diagram illustrating functional components of the DLNA network;

FIG. 6 illustrates an exemplary system environment for implementing a method for controlling an electronic device according to an embodiment of the present disclosure;

FIG. 7 is a flowchart illustrating a method for controlling an electronic device according to an embodiment of the present disclosure;

FIG. 8 is a flowchart for describing step S120 in greater detail;

FIG. 9 illustrates an example where a plurality of electronic devices are connected to one another via a network to share voice recognition results between the devices;

FIG. 10 illustrates an example where a plurality of electronic devices share voice recognition results therebetween and provide results of sharing to a user;

FIG. 11 is a flowchart illustrating an example of selecting an electronic device to conduct voice commands according to an embodiment of the present disclosure;

FIG. 12 illustrates an example where a voice command is performed by the electronic device selected in FIG. 11;

FIG. 13 is a flowchart illustrating an example of selecting an electronic device to perform voice commands according to an embodiment of the present disclosure;

FIG. 14 illustrates an example where a voice command is performed by the electronic device selected in FIG. 13;

FIG. 15 is a flowchart illustrating an example of selecting an electronic device to perform voice commands according to an embodiment of the present disclosure;

FIG. 16 illustrates an example where a voice command is performed by the electronic device selected in FIG. 15;

FIG. 17 is a flowchart illustrating an example of selecting an electronic device to perform voice commands according to an embodiment of the present disclosure;

FIG. 18 illustrates an example where a voice command is performed by the electronic device selected in FIG. 17;

FIG. 19 is a flowchart illustrating a method for controlling an electronic device according to an embodiment of the present disclosure;

FIG. 20 is a view for describing the embodiment shown in FIG. 19;

FIG. 21 is a flowchart illustrating a method for controlling an electronic device according to an embodiment of the present disclosure; and

FIG. 22 is a view for describing the embodiment shown in FIG. 21.

### DETAIL DESCRIPTION

The embodiments of the present disclosure described in detail above will be more clearly understood by the following detailed description. In what follows, the embodiments of the present disclosure will be described in detail with reference to appended drawings. Throughout the document, the same reference number refers to the same element. In addition, if it is determined that specific description about a well-known function or structure related to the present disclosure unnecessarily brings ambiguity to the understanding of the technical principles of the present disclosure, the corresponding description will be omitted.

In what follows, a display device related to the present disclosure will be described in more detail with reference to the appended drawings. The suffix of “module” and “unit” associated with a constituting element employed for the description below does not carry a meaning or a role in itself distinguished from the other.

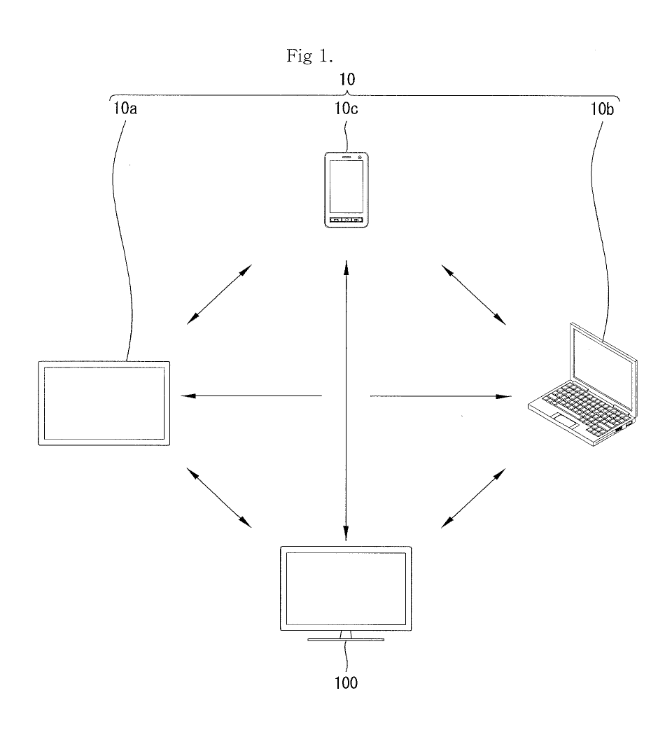

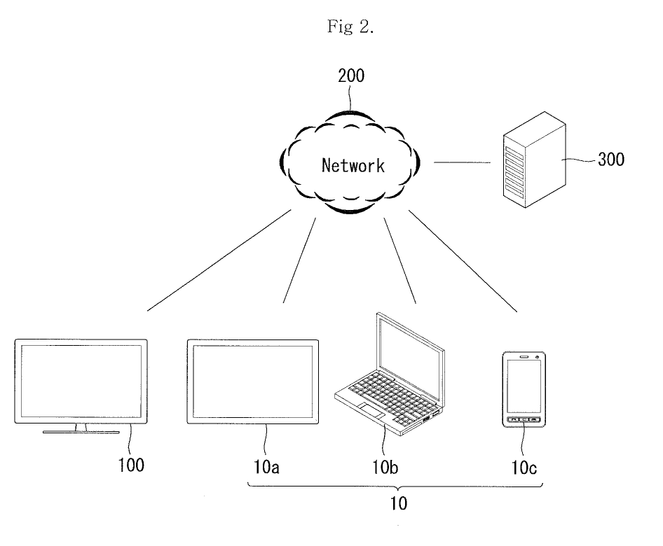

FIG. 1 is a schematic diagram illustrating a system of electronic devices according to an embodiment of the present disclosure. FIG. 2 is another schematic diagram illustrating the system of electronic devices according to an embodiment of the present disclosure.

Referring to FIGS. 1 and 2, a system environment includes the mobile terminal 100, a plurality of electronic devices 100, 10, a network 200, and a server 300 connected to the network 200.

Referring to FIG. 1, electronic devices 100 and the plurality of external electronic devices 10 can each communicate with the network 200. For example, electronic devices 100 and the plurality of external electronic devices 10 can receive multimedia content from the server 300.

The network 200 may include at least a mobile communications network, wired or wireless Internet, or a broadcast network.

The plurality of electronic devices 100, 10 may include at least stationary or mobile terminals. For example, the plurality of electronic devices 100, 10 may include handheld phones, smart phones, computers, laptop computers, personal digital assistants (PDAs), portable multimedia players (PMPs), personal navigation devices, or mobile Internet devices (MIDs).

The plurality of electronic devices 100 and 10 include a first electronic device 100, a second electronic device 10a, a third electronic device 10b, and a fourth electronic device 10c.

For purposes of illustration, as shown in FIGS. 1 and 2, the first, second, third, and fourth electronic devices 100, 10a, 10b, and 10c are a DTV (Digital TV), a mobile terminal, such as a tablet PC, a mobile terminal, such as a mobile phone, and a personal computer or laptop computer, respectively.

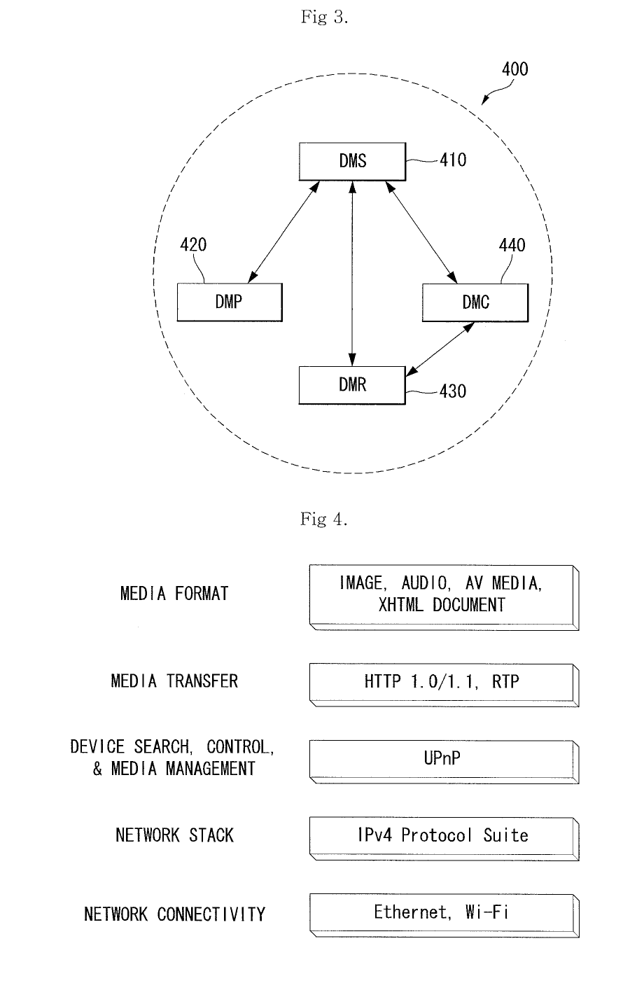

FIG. 3 is a conceptual diagram illustrating a Digital Living Network Alliance (DLNA) network according to an embodiment of the present disclosure. The DLNA is an organization that creates standards for sharing content, such as music, video, or still images between electronic devices over a network. The DLNA is based on the Universal Plug and Play (UPnP) protocol.

The DLNA network 400 may comprise a digital media server (DMS) 410, a digital media player (DMP) 420, a digital media render (DMR) 430, and a digital media controller (DMC) 440.

The DLNA network 400 may include at least the DMS 410, DMP 420, DMR 430, or DMC 440. The DLNA may provide a standard for compatibility between each of the devices. Moreover, the DLNA network 300 may provide a standard for compatibility between the DMS 410, the DMP 420, the DMR 430, and the DMC 440.

The DMS 410 can provide digital media content. That is, the DMS 410 is able to store and manage the digital media content. The DMS 410 can receive various commands from the DMC 440 and perform the received commands. For example, upon receiving a play command, the DMS 410 can search for content to be played back and provide the content to the DMR 430. The DMS 410 may comprise a personal computer (PC), a personal video recorder (PVR), and a set-top box, for example.

The DMP 420 can control either content or electronic devices, and can play back the content. That is, the DMP 420 is able to perform the function of the DMR 430 for content playback and the function of the DMC 440 for control of other electronic devices. The DMP 420 may comprise a television (TV), a digital TV (DTV), and a home sound theater, for example.

The DMR 430 can play back the content received from the DMS 410. The DMR 430 may comprise a digital photo frame.

The DMC 440 may provide a control function for controlling the DMS 410, the DMP 420, and the DMR 430. The DMC 440 may comprise a handheld phone and a PDA, for example.

In some embodiments, the DLNA network 300 may comprise the DMS 410, the DMR 430, and the DMC 440. In other embodiments, the DLNA network 300 may comprise the DMP 420 and the DMR 430.

In addition, the DMS 410, the DMP 420, the DMR 430, and the DMC 440 may serve to functionally discriminate the electronic devices from each other. For example, if a handheld phone has a playback function as well as a control function, the handheld phone may be the DMP 420. Alternatively, the DTV may be configured to manage content and, therefore, the DTV may serve as the DMS 410 as well as the DMP 420.

In some embodiments, the plurality of electronic devices 100, 10 may constitute the DLNA network 400 while performing the function corresponding to at least the DMS 410, the DMP 420, the DMR 430, or the DMC 440.

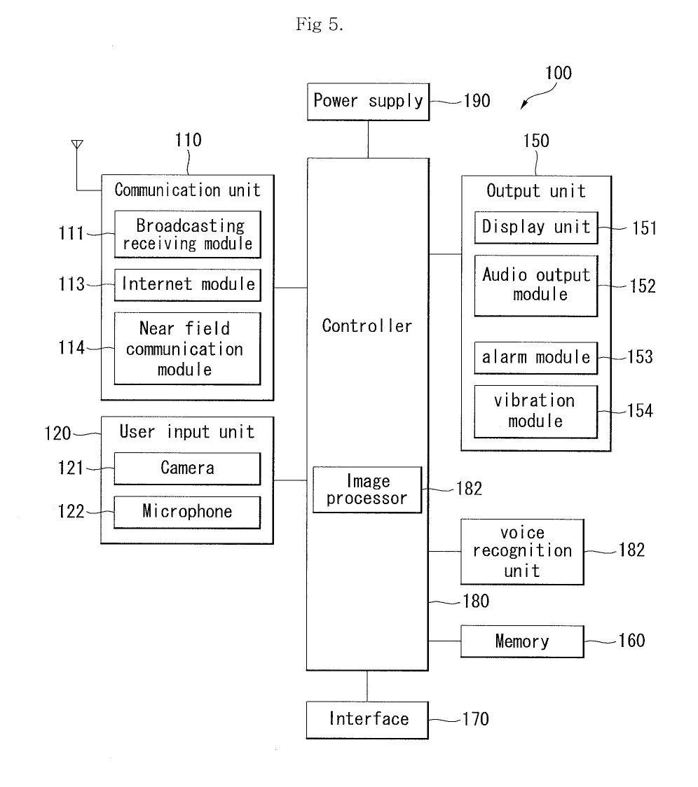

FIG. 5 is a block diagram illustrating functional components of the DLNA network. The functional components of the DLNA may comprise a media format layer, a media transport layer, a device discovery & control and media management layer, a network stack layer, and a network connectivity layer.

The media format layer may use images, audio, audio-video (AV) media, and Extensible Hypertext Markup Language (XHTML) documents.

The media transport layer may use a Hypertext Transfer Protocol (HTTP) 1.0/1.1 networking protocol for streaming playback over a network. Alternatively, the media transport layer may use a real-time transport protocol (RTP) networking protocol.

The device discovery & control and media management layer may be directed to UPnP AV Architecture or UPnP Device Architecture. For example, a simple service discovery protocol (SSDP) may be used for device discovery on the network. Moreover, a simple object access protocol (SOAP) may be used for control.

The network stack layer may use an Internet Protocol version 4 (IPv4) networking protocol. Alternatively, the network stack layer may use an IPv6 networking protocol.

The network connectivity layer may comprise a physical layer and a link layer of the network. The network connectivity layer may further include at least Ethernet, WiFi, or Bluetooth®. Moreover, a communication medium capable of providing an IP connection may be used.

Hereinafter, for purposes of illustration, an example is described where the first electronic device 100 is a TV including a DTV, an IPTV, etc. As used herein, the terms “module” and “unit” either may be used to denote a component without distinguishing one from the other.

FIG. 5 is a block diagram of the electronic device 100 according to an embodiment of the present disclosure. As shown, the electronic device 100 includes a communication unit 110, an A/V (Audio/Video) input unit 120, an output unit 150, a memory 160, an interface unit 170, a controller 180, and a power supply unit 190, etc. FIG. 5 shows the electronic device as having various components, but implementing all of the illustrated components is not a requirement. Greater or fewer components may alternatively be implemented.

In addition, the communication unit 110 generally includes one or more components allowing radio communication between the electronic device 100 and a communication system or a network in which the electronic device is located. For example, in FIG. 5, the communication unit includes at least one of a broadcast receiving module 111, a wireless Internet module 113, a short-range communication module 114.

The broadcast receiving module 111 receives broadcast signals and/or broadcast associated information from an external broadcast management server via a broadcast channel. Further, the broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

In addition, the broadcast associated information may refer to information associated with a broadcast channel, a broadcast program or a broadcast service provider.

Further, the broadcast signal may exist in various forms. For example, the broadcast signal may exist in the form of an electronic program guide (EPG) of the digital multimedia broadcasting (DMB) system, and electronic service guide (ESG) of the digital video broadcast-handheld (DVB-H) system, and the like.

The broadcast receiving module 111 may also be configured to receive signals broadcast by using various types of broadcast systems. In particular, the broadcast receiving module 111 can receive a digital broadcast using a digital broadcast system such as the multimedia broadcasting-terrestrial (DMB-T) system, the digital multimedia broadcasting-satellite (DMB-S) system, the digital video broadcast-handheld (DVB-H) system, the data broadcasting system known as the media forward link only (MediaFLO®), the integrated services digital broadcast-terrestrial (ISDB-T) system, etc.

The broadcast receiving module 111 can also be configured to be suitable for all broadcast systems that provide a broadcast signal as well as the above-mentioned digital broadcast systems. In addition, the broadcast signals and/or broadcast-associated information received via the broadcast receiving module 111 may be stored in the memory 160.

The Internet module 113 supports Internet access for the electronic device and may be internally or externally coupled to the electronic device. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

Further, the short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

With reference to FIG. 5, the A/V input unit 120 is configured to receive an audio or video signal, and includes a camera 121 and a microphone 122. The camera 121 processes image data of still pictures or video obtained by an image capture device in a video capturing mode or an image capturing mode, and the processed image frames can then be displayed on a display unit 151.

Further, the image frames processed by the camera 121 may be stored in the memory 160 or transmitted via the communication unit 110. Two or more cameras 121 may also be provided according to the configuration of the electronic device.

In addition, the microphone 122 can receive sounds via a microphone in a phone call mode, a recording mode, a voice recognition mode, and the like, and can process such sounds into audio data. The microphone 122 may also implement various types of noise canceling (or suppression) algorithms to cancel or suppress noise or interference generated when receiving and transmitting audio signals.

In addition, the output unit 150 is configured to provide outputs in a visual, audible, and/or tactile manner. In the example in FIG. 5, the output unit 150 includes the display unit 151, an audio output module 152, an alarm module 153, a vibration module 154, and the like. In more detail, the display unit 151 displays information processed by the image electronic device 100. For examples, the display unit 151 displays UI or graphic user interface (GUI) related to a displaying image. The display unit 151 displays a captured or/and received image, UI or GUI when the image electronic device 100 is in the video mode or the photographing mode.

The display unit 151 may also include at least one of a Liquid Crystal Display (LCD), a Thin Film Transistor-LCD (TFT-LCD), an Organic Light Emitting Diode (OLED) display, a flexible display, a three-dimensional (3D) display, or the like. Some of these displays may also be configured to be transparent or light-transmissive to allow for viewing of the exterior, which is called transparent displays.

An example transparent display is a TOLED (Transparent Organic Light Emitting Diode) display, or the like. A rear structure of the display unit 151 may be also light-transmissive. Through such configuration, the user can view an object positioned at the rear side of the terminal body through the region occupied by the display unit 151 of the terminal body.

The audio output unit 152 can output audio data received from the communication unit 110 or stored in the memory 160 in a audio signal receiving mode and a broadcasting receiving mode. The audio output unit 152 outputs audio signals related to functions performed in the image electronic device 100. The audio output unit 152 may comprise a receiver, a speaker, a buzzer, etc.

The alarm module 153 generates a signal for informing an event generated from the electronic device 100. The event generated from the electronic device 100 may include a speaker's voice input, a gesture input, a message input, and various control inputs through a remote controller. The alarm module 153 may also generate a signal for informing the generation of an event in other forms (e.g., vibration) other than a video signal or an audio signal. The video signal or the audio signal may also be generated through the display unit 151 or the audio output module 152.

The vibration module 154 can generate particular frequencies inducing a tactile sense due to particular pressure and feedback vibrations having a vibration pattern corresponding to the pattern of a speaker's voice input through a voice input device; and transmit the feedback vibrations to the speaker.

The memory 160 can store a program for describing the operation of the controller 180; the memory 160 can also store input and output data temporarily. The memory 160 can store data about various patterns of vibration and sound corresponding to at least one voice pattern input from at least one speaker.

Further, the memory 160 can store an electronic program guide (EPG). The EPG includes schedules for broadcasts to be on air and other various information, such as titles of broadcast programs, names of broadcast stations, broadcast channel numbers, synopses of broadcast programs, reservation numbers of broadcast programs, and actors appearing in broadcast programs.

The memory 160 periodically receives through the communication unit 110 an EPG regarding terrestrial, cable, and satellite broadcasts transmitted from broadcast stations or receives and stores an EPG pre-stored in the external device 10 or 20. The received EPG can be updated in the memory 160. For instance, the first electronic device 100 includes a separate database (not shown) for storing the EPG, and data relating to the EPG are separately stored in an EPG database (not shown).

Furthermore, the memory 160 may include an audio model, a recognition dictionary, a translation database, a predetermined language model, and a command database which are necessary for the operation of the present disclosure.

The recognition dictionary can include at least one form of a word, a clause, a keyword, and an expression of a particular language.

The translation database can include data matching multiple languages to one another. For example, the translation database can include data matching a first language (Korean) and a second language (English/Japanese/Chinese) to each other. The second language is a terminology introduced to distinguish from the first language and can correspond to multiple languages. For example, the translation database can include data matching “ [symbol] ” in Korean to “I'd like to make a reservation” in English.

The command databases form a set of commands capable of controlling the electronic device 100. The command databases may exist in independent spaces according to content to be controlled. For example, the command databases may include a channel-related command database for controlling a broadcasting program, a map-related to command database for controlling a navigation program, a game-related command database for controlling a game program.

Each of one or more commands included in each of the channel-related command database, the map-related command database, and the game-related command database has a different subject of control.

For example, in “Channel Switch Command” belonging to the channel-related command database, a broadcasting program is the subject of control. In a “Command for Searching for the Path of the Shortest Distance” belonging to the map-related command database, a navigation program is the subject of control.

Kinds of the command databases are not limited to the above example, and they may exist according to the number of pieces of content which may be executed in the electronic device 100.

Meanwhile, the command databases may include a common command database. The common command database is not a set of commands for controlling a function unique to specific content being executed in the electronic device 100, but a set of commands which can be in common applied to a plurality of pieces of content.

For example, assuming that two pieces of content being executed in the electronic device 100 are game content and a broadcasting program, a voice command spoken in order to raise the volume during play of the game content may be the same as a voice command spoken in order to raise the volume while the broadcasting program is executed.

The memory 160 may also include at least one type of storage medium including a flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the electronic device 100 may be operated in relation to a web storage device that performs the storage function of the memory 160 over the Internet.

Also, the interface unit 170 serves as an interface with external devices connected with the electronic device 100. For example, the external devices can transmit data to an external device, receive and transmit power to each element of the electronic device 100, or transmit internal data of the electronic device 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The controller 180 usually controls the overall operation of a electronic device. For example, the controller 180 carries out control and processing related to image display, voice output, and the like. The controller 10 can further comprise a voice recognition unit 182 carrying out voice recognition upon the voice of at least one speaker and although not shown, a voice synthesis unit (not shown), a sound source detection unit (not shown), and a range measurement unit (not shown) which measures the distance to a sound source.

The voice recognition unit 182 can carry out voice recognition upon voice signals input through the microphone 122 of the electronic device 100 or the remote control 10 and/or the mobile terminal shown in FIG. 1; the voice recognition unit 182 can then obtain at least one recognition candidate corresponding to the recognized voice. For example, the voice recognition unit 182 can recognize the input voice signals by detecting voice activity from the input voice signals, carrying out sound analysis thereof, and recognizing the analysis result as a recognition unit. And the voice recognition unit 182 can obtain the at least one recognition candidate corresponding to the voice recognition result with reference to the recognition dictionary and the translation database stored in the memory 160.

The voice synthesis unit (not shown) converts text to voice by using a TTS (Text-To-Speech) engine. TTS technology converts character information or symbols into human speech. TTS technology constructs a pronunciation database for each and every phoneme of a language and generates continuous speech by connecting the phonemes. At this time, by adjusting magnitude, length, and tone of the speech, a natural voice is synthesized; to this end, natural language processing technology can be employed. TTS technology can be easily found in the electronics and telecommunication devices such as CTI, PC, PDA, and mobile devices; and consumer electronics devices such as recorders, toys, and game devices. TTS technology is also widely used for factories to improve productivity or for home automation systems to support much comfortable living. Since TTS technology is one of well-known technologies, further description thereof will not be provided.

A power supply unit 190 provides power required for operating each constituting element by receiving external and internal power controlled by the controller 180.

Also, the power supply unit 190 receives external power or internal power and supplies appropriate power required for operating respective elements and components under the control of the controller 180.

Further, various embodiments described herein may be implemented in a computer-readable or its similar medium using, for example, software, hardware, or any combination thereof.

For a hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For a software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

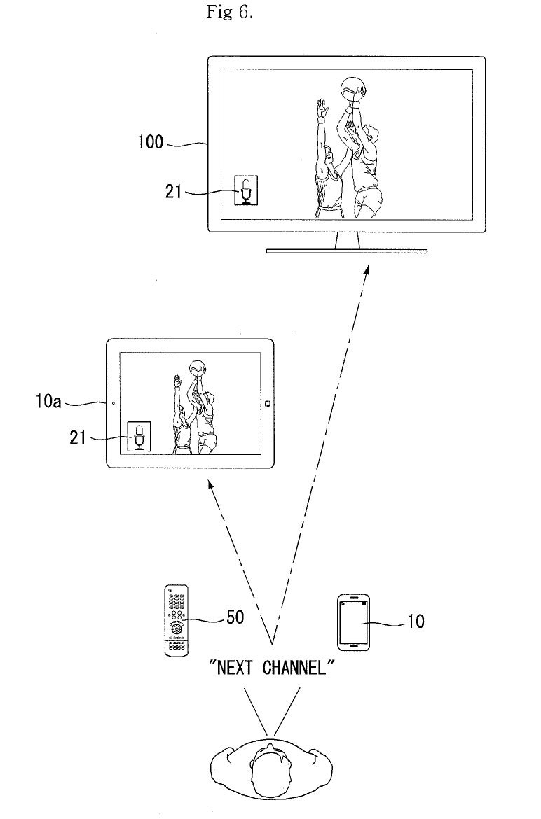

FIG. 6 illustrates an exemplary system environment for implementing a method for controlling an electronic device according to an embodiment of the present disclosure.

Referring to FIG. 6, a user can receive predetermined contents through the plurality of electronic devices 100 and 10a. The same or different contents can be provided to the electronic devices 100 and 10a that are connected to each other.

Referring to FIG. 6, while receiving the same content, the TV 100 and tablet PC 10a receive a predetermined voice command (for example, “next channel”) from the user.

The TV 100 and the tablet PC 10a are driven under the same operating system (OS) and have the same voice recognition module for recognizing the user's voice commands. Accordingly, the TV 100 and the tablet PC 10a generates the same output in response to the user's voice command.

For example, in the event that the user makes a voice command by saying “next channel” while a first broadcast program is provided to the TV 100 and the tablet PC 10a, both the TV 100 and the tablet PC 10a can change the channels from the first broadcast program to a second broadcast program. However, that the plurality of devices simultaneously process the use's voice command may cause a multi process to be unnecessarily performed. Accordingly, the voice command needs to be conducted by one of the TV 100 and the tablet PC 10a.

In an environment involving a plurality of devices, it can be determined by communication between the devices or by a third device managing the plurality of devices which of the plurality of devices is to carry out a user's voice command.

A microphone included in the TV 100 or tablet PC 10a can function as an input means that receives the user's voice command. According to an embodiment, the input means includes a microphone included in the remote controller 50 for controlling the TV 100 or included in the user's mobile phone 10. The remote controller 50 and the mobile phone 10 can perform near-field wireless communication with the TV 100 or the tablet PC 10a.

It has been heretofore described that in a system environment in which a plurality of electronic devices are connected to each other over a network, a specific electronic device handles a user's voice command.

Hereinafter, a method for controlling an electronic device according to an embodiment of the present disclosure is described with reference to the drawings. Specifically, examples are described where in a system environment involving a plurality of electronic devices, one electronic device conducts a user's voice command.

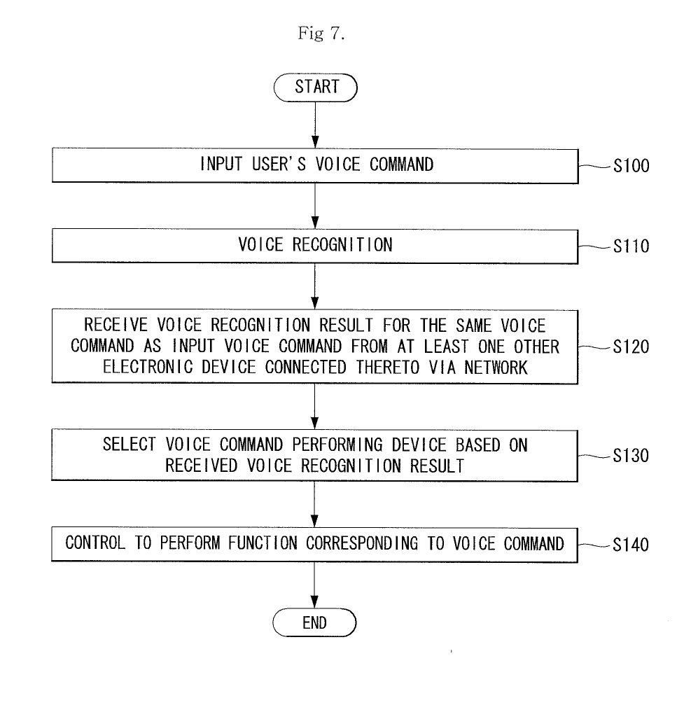

FIG. 7 is a flowchart illustrating a method for controlling an electronic device according to an embodiment of the present disclosure.

Referring to FIGS. 6 and 7, the first electronic device 100 receives a user's voice command in the device environment as shown in FIG. 6 (S100). For example, the TV 100 receives a voice command saying “next channel” from the user. Other electronic devices (for example, the tablet PC 10a) than the first electronic device 100, which are connected to the first electronic device over a network, may receive the user's voice command.

The controller 180 of the first electronic device 100 performs a voice recognition process in response to the received voice command (S110).

Likewise, the other electronic devices connected to the first electronic device 100 via the network may perform the voice recognition process in response to the voice command. For purposes of illustration, the voice command received by the other electronic devices is the same as the voice command received by the first electronic device 100.

Thereafter, the controller 180 of the first electronic device 100 receives a result of the voice recognition for the same voice command as the voice command received from at least one of the other electronic devices connected to the first electronic device 100 through the network (S120).

The voice recognition result received from the other electronic devices includes acknowledge information regarding whether the other electronic devices have normally received and recognized the user's voice command (also referred to as “Ack signal”). For example, when any one of the other electronic devices fails to normally receive or recognize the user's voice command, the electronic device needs to be excluded while selecting an electronic device to perform voice commands (also referred to as “voice command performing device” throughout the specification and the drawings) since it cannot carry out the user's voice commands.

Accordingly, the first electronic device 100 and the second electronic device 10a as shown in FIG. 6 need share the voice recognition results by exchanging the results therebetween.

The voice recognition result received from the other electronic devices includes information on time that the user's voice command was entered. For instance, when the first electronic device 100 receives a first voice command at a first time and the second electronic device 10a receives the first voice command at a second time, there might be a tiny difference in the time of recognizing the voice command in consideration of a distance difference between the two devices. However, when the time difference exceeds a predetermined interval, it is difficult to determine the voice command as being generated by the same user at the same time.

Accordingly, in sharing the voice recognition results between a plurality of devices, time information received from the devices may be taken into consideration. For instance, when a difference in input time between two devices is within a predetermined interval, the controller 180 may determine that the user voice commands have been input at the same time. In contrast, when the difference in input time is more than the predetermined interval, the controller 180 may determine that the voice command input at the first time has been reentered at the second time. The controlling method for an electronic device according to the embodiments of the present disclosure may apply to the former situation.

The voice command result received from the other electronic devices may include a magnitude (gain value) of the recognized voice signal, voice recognition ratio of each device, type of content or application in execution by each device upon voice recognition, and remaining power.

The controller 180 of the first electronic device 100 selects a device to perform the voice command based on the voice recognition result shared with the other electronic devices (S130).

A process of determining whether any electronic device performs the voice command based on information relating to various recognition results received from the other electronic devices will be described later.

Then, the controller 180 of the first electronic device 100 outputs a control signal of controlling the selected device to perform a function corresponding to the received voice command (S140).

The device that can be selected by the controller 180 of the first electronic device 100 to perform the voice command includes the first electronic device 100 or some other electronic device connected to the first electronic device 100 via a predetermined network.

Accordingly, when the first electronic device 100 is selected to perform the voice command, the controller 180 may enable the first electronic device 100 to directly perform a function corresponding to the voice command. When any one of the other electronic devices connected to the first electronic device 100 via the network is selected to perform the voice command, the controller 180 of the first electronic device 100 may transfer a control command enabling the selected electronic device to perform the function corresponding to the voice command.

Although the controller 180 of the first electronic device 100 automatically selects a device to perform the voice command based on the voice recognition result for each device in step S130, the embodiments of the present disclosure are not limited thereto. For instance, while the voice recognition result for each device is displayed on the display unit, a user may select a device to perform the voice command based on the displayed result.

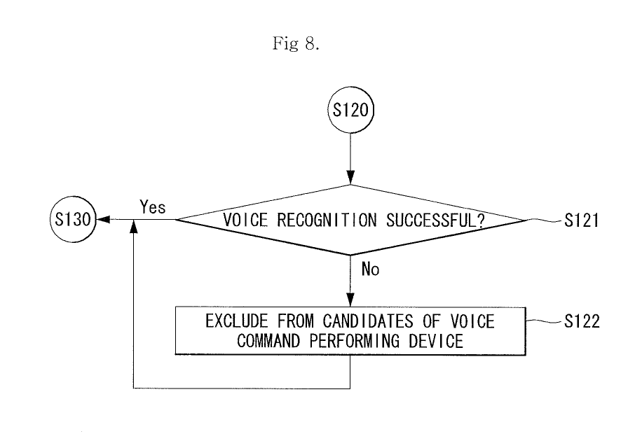

FIG. 8 is a flowchart for describing step S120 in greater detail.

Referring to FIG. 8, the controller 180 receives voice recognition results for the same voice command as a voice command input to the first electronic device 100 from other electronic devices connected to the first electronic device 100 via a network.

Then, the first electronic device 100 identifies whether the voice recognition has been successfully done based on the voice recognition result (S121). When the successful voice recognition has been done, step S130 is carried out.

However, when the voice recognition has failed, the controller 180 of the first electronic device 100 excludes the device having failed the voice recognition from candidate devices to perform the voice command (S122).

For instance, referring to FIG. 6, in response to a user's voice command saying “next channel”, the first electronic device 100 and the second electronic device 10a perform the voice command and then exchanges results therebetween. The first electronic device 100 receives the voice recognition result for the second electronic device 10a and, if the second electronic device 10a has failed to recognize the “next channel”, the controller 180 of the first electronic device 100 excludes the second electronic device 10a from the candidate devices to perform the voice command.

The first electronic device 100 may search the other electronic devices than the second electronic device 10a over the network to which the first electronic device 100 connects. When there are no other devices than the second electronic device 10a over the network, the controller 180 of the first electronic device 100 directly carries out the voice command.

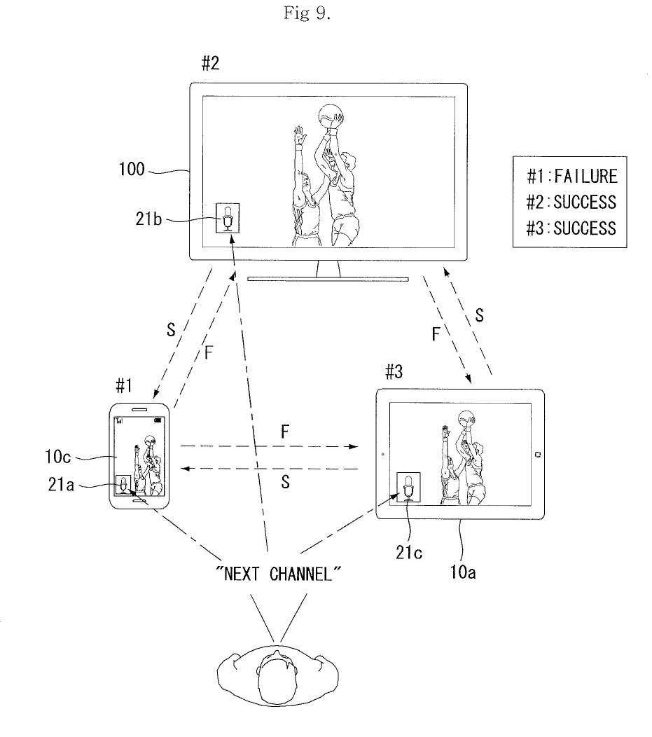

FIG. 9 illustrates an example where a plurality of electronic devices are connected to one another via a network to share voice recognition results between the devices.

For purposes of illustration, the first electronic device 100 is a TV, the second electronic device 10a is a tablet PC, and the third electronic device 10c is a mobile phone.

Referring to FIG. 9, a user generates a voice command by saying “next channel”.

In response to the voice command, the TV 100, the tablet PC 10a, and the mobile phone 10c perform voice recognition. Each of the devices 100, 10a, and 10c may share voice recognition results with other electronic devices connected thereto via the network. The voice recognition results as shared include whether the voice recognition has succeeded or failed. Based on the shared results, each electronic may identify that the mobile phone 10c has failed while the TV 100 and the tablet PC 10a have succeeded.

Although the first electronic device, i.e. TV 100, has been selected to perform the voice command, other electronic devices may also be selected as a device for conducting the voice command. For example, a specific electronic device may be preset to carry out the user's voice command according to settings of a network in which a plurality of electronic devices are included.

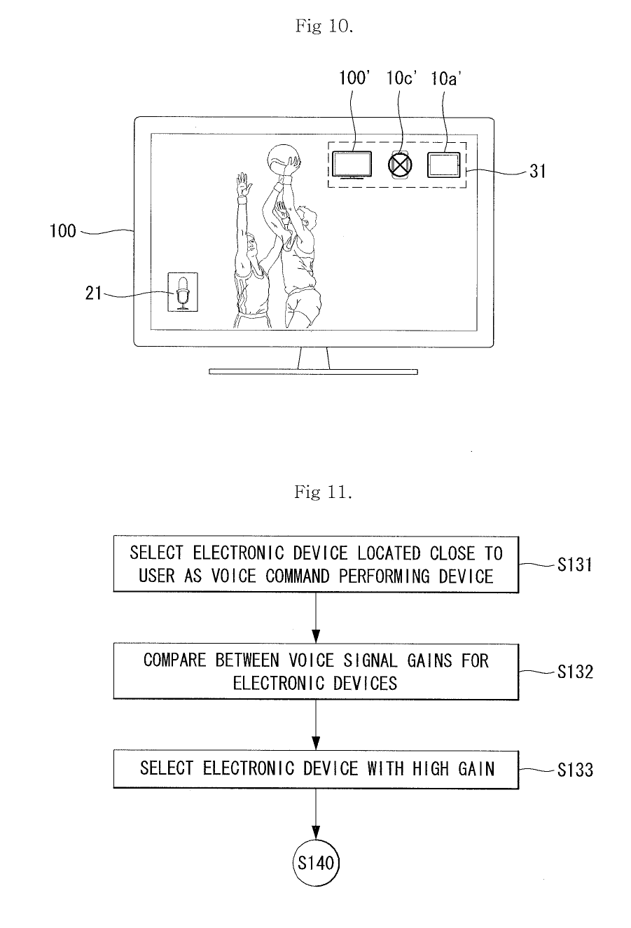

FIG. 10 illustrates an example where a plurality of electronic devices share voice recognition results therebetween and provide results of sharing to a user.

Referring to FIGS. 9 and 10, each electronic device displays identification information 31 indicating voice recognition results of the other electronic devices on the screen. The identification information 31 includes device IDs 100′, 10a′, and 10c′ and information indicating whether the voice recognition succeeds or not.

The device IDs 100′, 10a′, and 10c′ include icons, such as a TV icon, a mobile phone icon, and a tablet PC icon.

The information indicating whether the voice recognition succeeds includes information indicating a success or failure of the voice recognition. For example, the information indication a success or failure of the voice recognition may be represented by highlighting the device ID (the TV icon, mobile phone icon, or tablet PC icon) or by using text message or graphic images.

As identification information on any one device is selected by a user's manipulation while the identification information on the devices are displayed, the controller 180 of the first electronic device 100 may select the device corresponding to the selected identification device as a device to conduct the user's voice command.

Hereinafter, various embodiments where the controller 180 of the first electronic device 100 chooses an electronic device to perform voice commands are described with reference to relating drawings.

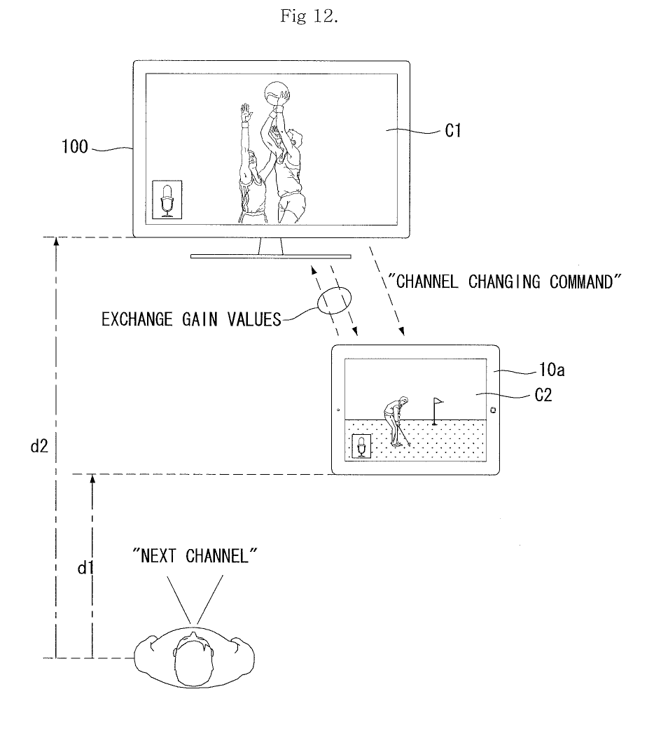

FIG. 11 is a flowchart illustrating an example of selecting an electronic device to conduct voice commands according to an embodiment of the present disclosure. FIG. 12 illustrates an example where a voice command is performed by the electronic device selected in FIG. 11.

Referring to FIGS. 11 and 12, the controller 180 of the first electronic device 100 selects an electronic device to perform voice commands based on voice recognition results received from other electronic devices connected thereto over a network.

According to an embodiment, the controller 180 may select an electronic device located close to a user as conducting voice commands (S131).

The distances between the user and electronic devices may be compared therebetween based on the gain of a voice signal received for each electronic device.

Referring to FIG. 12, while in execution of first content C1, the first electronic device 100 and the second electronic device 10a receive the user's voice command (“next channel”) and perform voice recognition. Each electronic device shares voice recognition results with the other electronic devices. For instance, in the embodiment described in connection with FIG. 12, voice recognition results shared between the first electronic device 100 and the second electronic device 10a include gains of the received voice signals.

The controller 180 of the first electronic device 100 compares a first gain of a voice signal received by the first electronic device 100 with a second gain received from the second electronic device 10a, and selects one having a smaller gain as performing the voice commands (S133).

Since a distance d1 between the second electronic device 10a and the user is shorter than a distance d2 between the first electronic device 100 and the user, the first electronic device 100 may select the second electronic device 10a as an electronic device conducting the voice commands.

Accordingly, the controller 180 of the first electronic device 100 transfers a command allowing the second electronic device 10a to perform a function corresponding to the voice command (“next channel”) to the second electronic device 10a. Then, in response to the above command, the second electronic device 10a changes the present channel to the next channel.

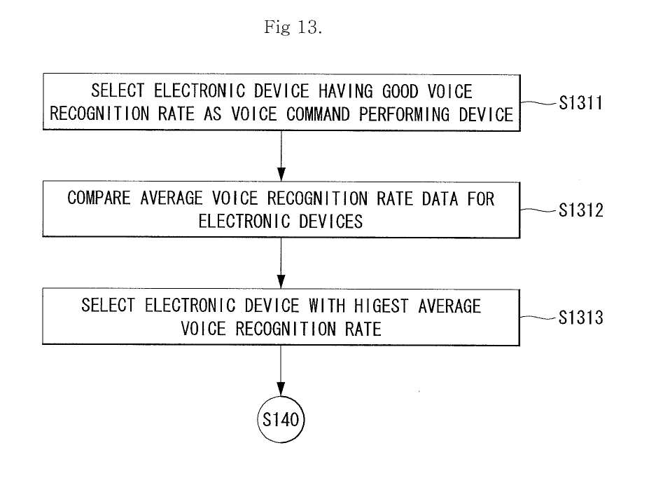

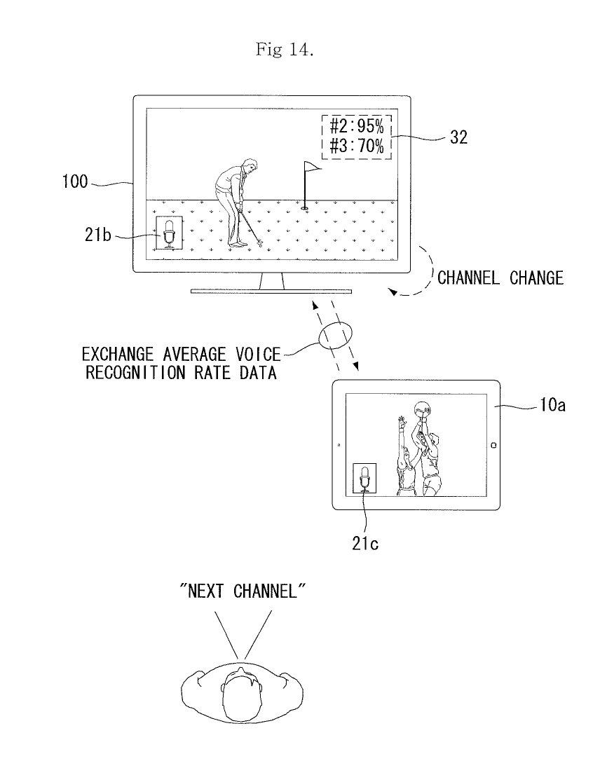

FIG. 13 is a flowchart illustrating an example of selecting an electronic device to perform voice commands according to an embodiment of the present disclosure. FIG. 14 illustrates an example where a voice command is performed by the electronic device selected in FIG. 13.

Referring to FIGS. 13 and 14, the controller 180 of the first electronic device 100 selects an electronic device for conducting voice commands based on voice recognition results received from other electronic devices connected thereto over a network.

According to an embodiment, the controller 180 selects an electronic device having a good voice recognition rate as a device for performing the voice command (S1311).

The “voice recognition rate” may refer to a current voice recognition rate or an average voice recognition rate for each device. Accordingly, when the average voice recognition rate is considered for the selection, an electronic device having a good average voice recognition rate may be chosen as the command performing device even though the current voice recognition rate of the electronic device is poor.

Each electronic device shares results of performing the voice recognition with other electronic devices. For instance, in the embodiment described in connection with FIG. 14, results of performing voice recognition as shared between the first electronic device 100 and the second electronic device 10a include voice recognition rate data (or average voice recognition rate data) for each device.

The controller 180 of the first electronic device 100 compares an average recognition rate (95%) of the first electronic device 100 with an average recognition rate (70%) of the second electronic device 10a (S1312) and selects one having a larger value as the voice command performing device (S1313).

Accordingly, the controller 180 of the first electronic device 100 performs a command enabling a function corresponding to the voice command (“next channel”) to be performed, so that a present channel is changed to its next channel.

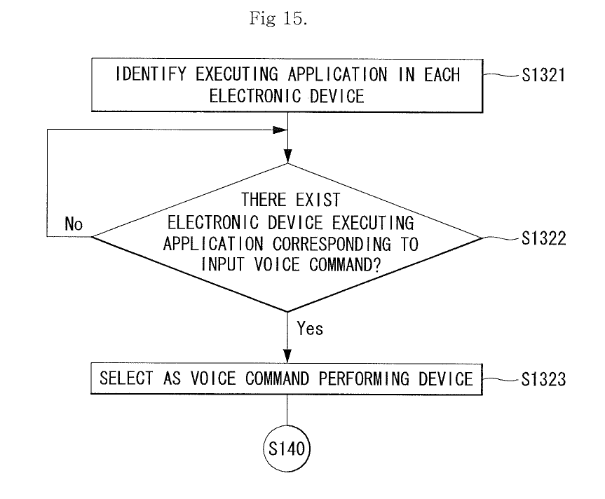

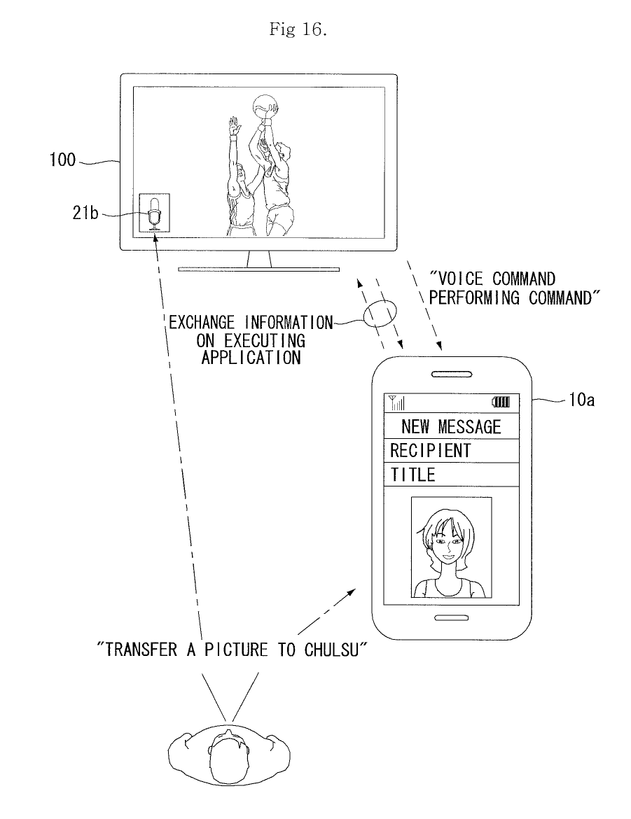

FIG. 15 is a flowchart illustrating an example of selecting an electronic device to perform voice commands according to an embodiment of the present disclosure. FIG. 16 illustrates an example where a voice command is performed by the electronic device selected in FIG. 15.

According to an embodiment, the controller 180 identifies an application in execution in each electronic device (S1321).

Then, the controller 180 identifies whether there is an electronic device executing an application corresponding to an input voice command among a plurality of electronic devices (S1322), and if any (yes in step S1322), the controller 180 of the first electronic device 100 selects the electronic device as a voice command performing device (S1323).

According to an embodiment, the method for controlling a mobile terminal may select an electronic device that may perform a user input voice command most efficiently in an environment involving a plurality of electronic devices to effectively conduct the voice command.

For instance, a voice command saying “transfer a picture to Chulsu” enables a predetermined picture to be transferred to an electronic device through emailing or MMS mailing. Accordingly, when there is any electronic device executing an application relating to messaging or emailing among a plurality of electronic devices, it is most efficient for the corresponding electronic device to perform the voice command.

Referring to FIG. 16, the second electronic device 10a is executing an email application, and the first electronic device 100 is executing a broadcast program. Under this circumstance, when the voice command saying “transfer a picture to Chulsu” is input to each of the electronic devices, the first electronic device 100 and the second electronic device 10a may exchange the programs (or contents) presently in execution to each other.

The first electronic device 100 determines that the second electronic device 10a may efficiently perform the newly input voice command through the program executed by the second electronic device 10a, and selects the second electronic device 10a as the voice command performing device.

Accordingly, the controller 180 of the first electronic device 100 may transfer a command to the second electronic device 10a to enable a function corresponding to the voice command (“transfer a picture to Chulsu”) to be performed. In response to the command, the second electronic device 10a may perform the voice command.

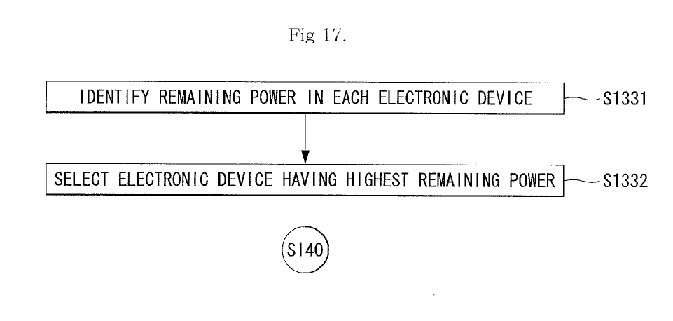

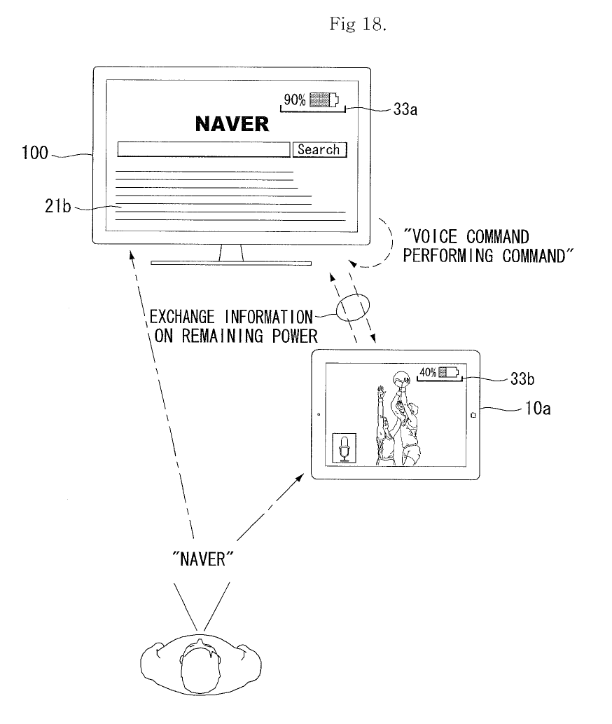

FIG. 17 is a flowchart illustrating an example of selecting an electronic device to perform voice commands according to an embodiment of the present disclosure. FIG. 18 illustrates an example where a voice command is performed by the electronic device selected in FIG. 17.

According to an embodiment, the controller 180 identifies remaining power for each electronic device (S1331), and selects an electronic device having more remaining power as the voice command performing device (S1332).

A predetermined amount of power may be consumed when a new voice command is performed in an environment involving a plurality of electronic devices. Accordingly, for example, an electronic device holding more power may be selected to perform the voice command.

Referring to FIG. 18, the first electronic device 100 and the second electronic device 10a receive a voice command (“Naver”) and perform voice recognition. Then, the first electronic device 100 and the second electronic device 10a share results of the voice recognition.

The shared voice recognition results include the amount of power remaining in each device. As it is identified that the first electronic device 100 has 90% remaining power, and the second electronic device 10a has 40% remaining power, the first electronic device 100 may perform a function (access to an Internet browser) corresponding to the voice command (“Naver”).

A user may manually select the voice command performing device through power icons 33a and 33b displayed on the display unit to represent remaining power as well.

In the method for controlling an electronic device according to an embodiment, operations after a voice command has been performed by a specific electronic device are now be described.

Among a plurality of electronic devices, the first electronic device 100 may directly perform a voice command or may enable some other electronic device networked thereto to perform the voice command.

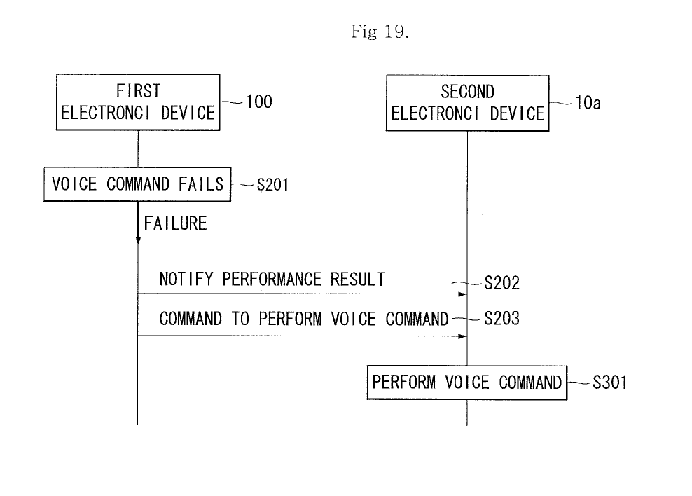

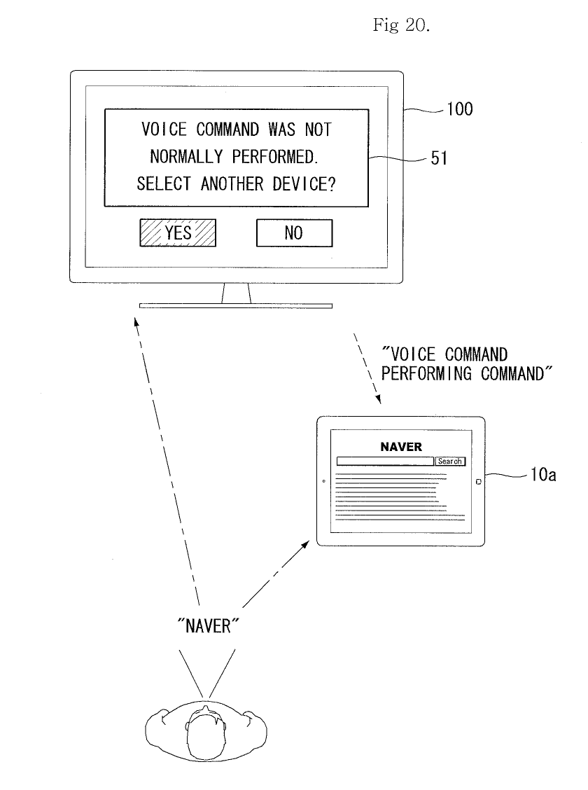

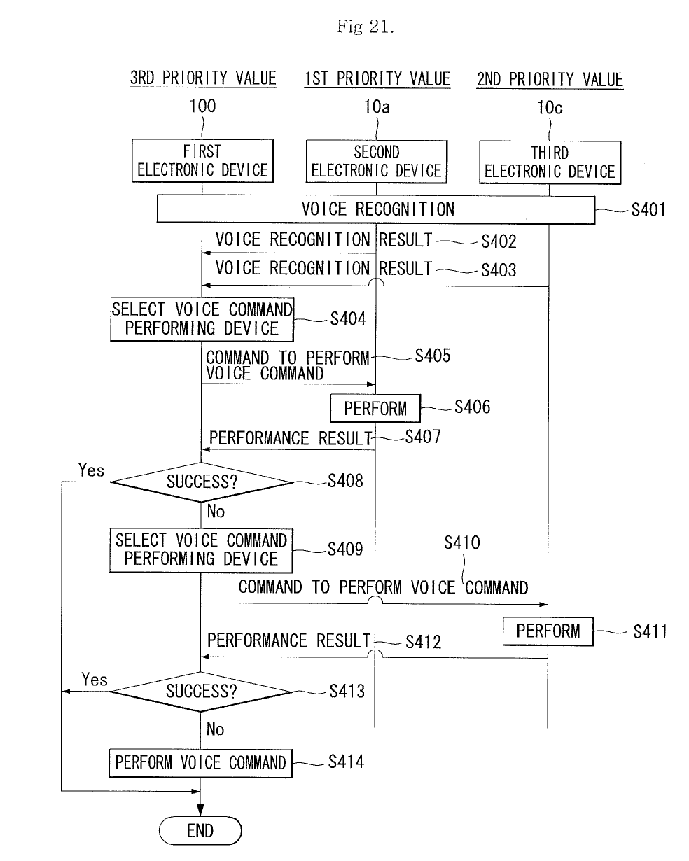

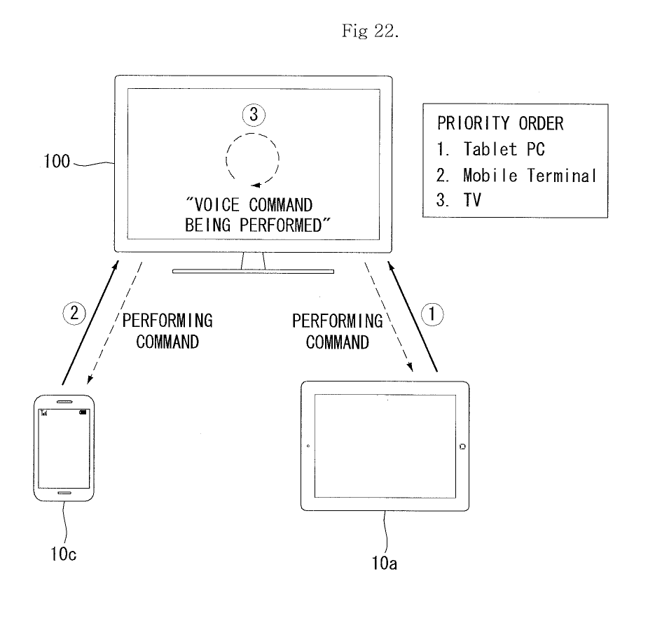

Operations of the first electronic device 100 after the first electronic device 100 performs the voice command are described with reference to FIGS. 19 and 20, and operations of other electronic devices after the other electronic devices connected to the first electronic device 100 via a network perform the voice command are described with reference to FIGS. 21 and 22.

FIG. 19 is a flowchart illustrating a method for controlling an electronic device according to an embodiment of the present disclosure. FIG. 20 is a view for describing the embodiment shown in FIG. 19.

Referring to FIGS. 19 and 20, the first electronic device 100 performs a voice command (S201).

When the voice command fails, the first electronic device 100 notifies a result of performing the voice command (i.e., failure) to the second electronic device 10a (S202).

Receiving the performance result, the second electronic device 10a determines whether there are other devices than the first electronic device 100 and the second electronic device 10a in the network. When it is determined that no other devices are present in the network, the first electronic device 100 may automatically perform the recognized voice command on its own.

Separately from the operation notifying the performance result, the first electronic device 100 may also transfer a command enabling the voice command to be performed to the second electronic device 10a (S203). In response, the second electronic device 10a performs the voice command (S301).

Referring to FIG. 20, the first electronic device 100 sometimes fails to perform the input voice command (“Naver”-access to an Internet browser) for a predetermined reason (for example, due to an error in accessing a TV network).

In such a case, the first electronic device 100 may display a menu 51 indicating a failure in performing the voice command on the display unit 151. The menu 51 includes an inquiry on whether to select another electronic device to perform the voice command.

While the menu 51 is provided, the controller 180 of the first electronic device 100 transfers a command enabling the second electronic device 10a to perform the voice command to the second electronic device 10a by a user's manipulation (selection of another device).

Hereinafter, operations after the voice command is performed by other electronic devices than the first electronic device 100 that is able to select the voice command performing device are described.

FIG. 21 is a flowchart illustrating a method for controlling an electronic device according to an embodiment of the present disclosure. FIG. 22 is a view for describing the embodiment shown in FIG. 21.

Referring to FIG. 21, the first electronic device 100, the second electronic device 10a, and the third electronic device 10c each receive a user voice command and perform voice recognition (S401).

The second electronic device 10a transmits a voice recognition result to the first electronic device 100 (S402). The third electronic device 10c also transmits a voice recognition result to the first electronic device 100 (S403).

Based on the voice recognition results received from the second electronic device 10a and the third electronic device 10c, the controller 180 of the first electronic device 100 selects a voice command performing device (S404).

For purposes of illustration, the second electronic device 10a has a first priority value, the third electronic device 10c a second priority value, and the first electronic device 100 a third priority value in relation to an order in which the voice command is to be performed by the electronic devices.

The priority values may be determined based on the voice recognition results from the electronic devices. For example, the priority values may be assigned in an order of electronic devices satisfying better conditions to perform the input voice command among a plurality of electronic devices.

For example, at least one factor of the user-device distance, voice recognition rate, relevancy between the executing program and a program to be executed through the input voice command, and remaining power in each device may be considered to determine the order of the priority values.

However, the embodiments of the present disclosure are not limited to the above-listed factors. For example, when a predetermined voice input is received under the circumstance where one of the plurality of electronic devices does not execute a program and the other electronic devices execute their respective corresponding programs, whether to execute a program may be also taken into consideration to determine a priority value.

According to the determined priority values, the first electronic device 100 transfers a control command to the second electronic device 10a to perform the voice command (S405). In response to the control command, the second electronic device 10a may perform the voice command (S406).

Thereafter, the second electronic device 10a transmits a result of performing the voice command to the first electronic device 100 (S407).

When the voice command is not normally performed by the second electronic device 10a (No in step S408), the first electronic device 100 searches for an electronic device having the next highest priority value to reselect a voice command performing device (S409).

The first electronic device 100 selects the third electronic device 10c having the second highest priority value, and transfers a command to the third electronic device 10c to perform the voice command (S410).

In response, the third electronic device 10c performs the voice command (S411), and transfers a result to the first electronic device 100 (S412).

When the voice command is not normally performed by the third electronic device 10c (No in step S413), the first electronic device 100 searches for an electronic device having the next highest priority value to select a voice command performing device again.

Since the first, second, and third electronic devices are connected to one another over the network, the first electronic device 100 performs the voice command (S414).

Referring to FIG. 22, when the tablet PC, mobile phone, and TV have the highest, second highest, and lowest priority values, respectively, with respect to performance of the voice command, the TV 100 first transfers a command for performing the voice command to the tablet PC 10a, and the tablet PC 10a then transfers a performance result to the TV 100 (See \textcircled{1}).

The TV 100 transfers the command for performing the voice command to the mobile phone 10c, which in turns conveys a performance result to the TV 100 (See \textcircled{2}).

When neither the tablet PC 10a nor the mobile phone 10c normally performs the voice command, the TV 100 may directly perform the voice command (See \textcircled{3}).

The method for controlling of the electronic device according to embodiments of the present disclosure may be recorded in a computer-readable recording medium as a program to be executed in the computer and provided. Further, the method for controlling a display device and the method for displaying an image of a display device according to embodiments of the present disclosure may be executed by software. When executed by software, the elements of the embodiments of the present disclosure are code segments executing a required operation. The program or the code segments may be stored in a processor-readable medium or may be transmitted by a data signal coupled with a carrier in a transmission medium or a communication network.

The computer-readable recording medium includes any kind of recording device storing data that can be read by a computer system. The computer-readable recording device includes a ROM, a RAM, a CD-ROM, a DVD±ROM, a DVD-RAM, a magnetic tape, a floppy disk, a hard disk, an optical data storage device, and the like. Also, codes which are distributed in computer devices connected by a network and can be read by a computer in a distributed manner are stored and executed in the computer-readable recording medium.

As the present disclosure may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An electronic device comprising:
a communication unit configured to perform communication with at least a first electronic device included in a group of related electronic devices; and
a controller configured to:
identify, for each electronic device included in the group of related electronic devices, a voice recognition result of a voice command input provided by a user,
select, from among the group of related electronic devices, a voice command performing device based on the identified voice recognition results, and
control the voice command performing device to perform a function corresponding to the voice command input.

2. The electronic device of claim 1, further comprising:
a voice input unit configured to input voice command inputs,
wherein the electronic device is included in the group of related electronic devices, and
wherein the controller is configured to recognize the voice command input provided by the user based on input received through the voice input unit.

3. The electronic device of claim 1, wherein the controller is configured to:
identify, for each electronic device included in the group of related electronic devices, a voice recognition result that indicates whether or not recognition of the voice command input was successful at the corresponding electronic device, and
select, from among the group of related electronic devices, a voice command performing device based on the identified voice recognition results that indicate whether or not recognition of the voice command input was successful.

4. The electronic device of claim 1:
wherein the voice command input provided by the user is a single voice command made by the user,
wherein multiple electronic devices included in the group of related electronic devices receive voice input based on the single voice command such that the single voice command results in multiple voice inputs to the group of related electronic devices, and
wherein the controller is configured to determine that the multiple voice inputs relate to the single voice command as opposed to multiple voice commands provided by the user.

5. The electronic device of claim 1, wherein the controller is configured to:
select, from among the group of related electronic devices, multiple voice command performing devices based on the identified voice recognition results, and
control the multiple voice command performing devices to perform a function corresponding to the voice command input.

6. The electronic device of claim 5, wherein the multiple voice command performing devices comprise the electronic device and the first electronic device.

7. The electronic device of claim 1, wherein the controller is configured to select only one electronic device from the group of related electronic devices as the voice command performing device based on the identified voice recognition results.

8. The electronic device of claim 1, wherein the controller is configured to:
identify, for each electronic device included in the group of related electronic devices, a distance from the user; and
select the voice command performing device based on the identified distances from the user.

9. The electronic device of claim 1, wherein the controller is configured to:
identify, for each electronic device included in the group of related electronic devices, an average voice recognition rate; and
select the voice command performing device based on the identified average voice recognition rates.

10. The electronic device of claim 1, wherein the controller is configured to:
identify, for each electronic device included in the group of related electronic devices, a type of application executing at a time of the voice command input provided by the user; and
select the voice command performing device based on the identified types of applications executing at the time of the voice command input provided by the user.

11. The electronic device of claim 1, wherein the controller is configured to:
identify, for each electronic device included in the group of related electronic devices, an amount of battery power remaining; and
select the voice command performing device based on the identified amounts of battery power remaining.

12. The electronic device of claim 1, wherein the controller is configured to perform a function corresponding to the voice command input and provide, to the first electronic device, feedback regarding a performance result for the function corresponding to the voice command.

13. The electronic device of claim 12, wherein, when the function corresponding to the voice command input is performed abnormally, the controller is configured to select the first electronic device as the voice command performing device and control the first electronic device to perform the function corresponding to the voice command input.

14. The electronic device of claim 1, wherein the communication unit is configured to communicate with the first electronic device through a Digital Living Network Alliance (DLNA) network.

15. A system comprising:
a first electronic device configured to receive a user's voice command; and
a second electronic device connected to the first electronic device via a network and configured to receive the user's voice command,
wherein at least one component of the system is configured to:
identify, for each of the first and second electronic devices, a voice recognition result for the user's voice command,
select at least one of the first electronic device and the second electronic device as a voice command performing device based on the identified voice recognition results, and
control the voice command performing device to perform a function corresponding to the user's voice command.

16. The system of claim 15, wherein the at least one component of the system is configured to select one of the first electronic device and the second electronic device as the voice command performing device based on the voice recognition results.

17. The system of claim 15, wherein the network includes a DLNA network.

18. A method for controlling an electronic device comprising:
identifying, for each electronic device included in a group of related electronic devices, a voice recognition result of a voice command input provided by a user;
selecting, from among the group of related electronic devices, a voice command performing device based on the identified voice recognition results; and
outputting a control signal that controls the voice command performing device to perform a function corresponding to the voice command input.

19. The method for claim 18, wherein the group of related electronic devices communicate through a DLNA network.

20. The method of claim 18, further comprising:
receiving, at an electronic device included in the group of related electronic devices, the voice command input provided by the user,
wherein the electronic device that received the voice command input provided by the user selects the voice command performing device and outputs the control signal.
